(19) United States
(12) Patent Application Publication
(10) Pub. No.: US 2013/0027308 A1
(43) Pub. Date: Jan. 31, 2013

(54) WHEEL MODULE FOR INPUT DEVICE

(71) Applicant: Chun-Ching Peng, Taipei (TW)

(72) Inventor: Chun-Ching Peng, Taipei (TW)

(73) Assignee: PRIMAX ELECTRONICS LTD., Taipei (TW)

(21) Appl. No.: 13/328,609

(22) Filed: Dec. 16, 2011

(30) Foreign Application Priority Data
Jul. 29, 2011 (TW) 100126976

(51) Int. Cl. G06F 3/033

(52) U.S. Cl. 345/163

(57) ABSTRACT

A wheel module for an input device includes a fixing shaft, a wheel and a swinging arm. The wheel has a recess or a hollow groove, so that a first saw-toothed structure and a second saw-toothed structure are formed within the wheel. When the contacting part of the swinging arm is contacted with the first saw-toothed structure, the wheel is operated in a first click-feeling mode. Whereas, when the contacting part of the swinging arm is contacted with the second saw-toothed structure, the wheel is operated in a second click-feeling mode.

### FIELD OF THE INVENTION

The present invention relates to a wheel module, and more particularly to a wheel module for an input device.

### BACKGROUND OF THE INVENTION

With increasing development of scientific technologies, multimedia products and computers become essential in our daily lives. In the computer systems, peripheral input devices play important roles for communicating the computer systems and the users. The common peripheral input devices for the computer systems include for example mice, keyboards, microphones, or the like. When a mouse is held on the palm of a user's hand, the user may move the mouse to control movement of the cursor shown on the computer screen. As the cursor is moved, the motion trajectory of the mouse cursor is shown on the computer screen. Since mice are very easy-to-use and can comply with the usual practices of most users, mice are the most prevailing among these peripheral input devices.

Please refer to FIGS. 1 and 2. FIG. 1 is a schematic perspective view illustrating the outward appearance of a conventional mouse device. The conventional mouse device is disclosed in for example U.S. Pat. No. 7,733,328. FIG. 2 is a schematic perspective view illustrating a wheel module for the mouse device as shown in FIG. 1.

As shown in FIGS. 1 and 2, the mouse device 100 comprises a casing 101, a wheel module 105, two control buttons 110, a detector (not shown), and an encoder (not shown). The detector and the encoder are used for detecting a motion of the casing 101 relative to a working surface, thereby generating a corresponding control signal to the computer system. According to the control signal, a motion trajectory of a mouse cursor is correspondingly controlled. By clicking the control button 110, a specified control command is executed to implement a corresponding function (e.g. a copying function or a character selection function).

Moreover, the wheel module 105 comprises a wheel 300, a pivotal arm 380 and a driving motor 385. By rotating the wheel 300, another specified control command is executed to implement a corresponding function (e.g. the function of scrolling the image frame shown on the computer, zooming in/out the picture or adjusting the sound volume). In addition, the wheel 300 has a corrugated inner surface 370. In a case that the pivotal arm 380 is driven by the driving motor 385 to be contacted with the corrugated inner surface 370, the user may sense a plurality of times of the click feeling once the wheel 300 is rotated for a revolution. In such way, the control command may be executed to have an additional function of controlling the magnitude. For example, each time of sensing the click feeling of the wheel 300 denotes that the picture is shrunken by25% or enlarged by25%.

Whereas, if the pivotal arm 380 is driven by the driving motor 385 to be separated from the corrugated inner surface 370, after the pushing force exerted on the wheel 300 is eliminated, the wheel 300 may be continuously rotated for a certain time period. In other words, the wheel 300 is rotated in a smooth-feeling manner without resulting in a click feeling. In such way, the control command may be executed to implement some other functions. For example, in order to scroll the image frame shown on the computer from the uppermost position to the lowermost position, the user may only push the wheel 300 once without the need of continuously pushing the wheel 300 to allow for rotation of the wheel 300. Until the image frame shown on the computer is scrolled to a desired position, the rotation of the wheel 300 is stopped.

Nowadays, as the professional computer software (e.g. the graphics software or the image processing software) becomes more and more diverse, its functionality is increased but the operations of the software are more complicated. Since the rotation of the wheel 300 of the wheel module 105 of the conventional mouse device 100 can provide a single click feeling, the functions provided by the conventional mouse device 100 fail to meet the requirements of most users. Therefore, the conventional tilt mouse device 100 needs to be further improved.

### SUMMARY OF THE INVENTION

The present invention relates to a wheel module with a plurality of click-feeling modes.

In accordance with an aspect of the present invention, there is provided a wheel module for an input device. The wheel module includes a fixing shaft, a wheel and a swinging arm. The wheel is rotatable relative to a central axial line of the fixing shaft. The wheel has a recess, which is disposed around the fixing shaft. A first inner surface of the recess has a first saw-toothed structure. A second inner surface of the recess opposite to the first inner surface has a second saw-toothed structure. The swinging arm includes a contacting part and a poking part. As the poking part is moved, the contacting part is selectively contacted with the first saw-toothed structure or the second saw-toothed structure, or separated from the first saw-toothed structure and the second saw-toothed structure. When the contacting part is contacted with the first saw-toothed structure, the wheel is operated in a first click-feeling mode. When the contacting part is contacted with the second saw-toothed structure, the wheel is operated in a second click-feeling mode. When the contacting part is separated from the first saw-toothed structure and the second saw-toothed structure, the wheel is operated in a smooth-feeling mode.

In an embodiment, the wheel module further provides an elastic force to the swinging arm. In response to the elastic force, the contacting part is contacted with the first saw-toothed structure or the second saw-toothed structure.

In an embodiment, the swinging arm is made of an elastic material for generating the elastic force.

In an embodiment, the wheel module further includes a spring, which is connected with the swinging arm for providing the elastic force.

In an embodiment, one indentation is arranged between every two adjacent ones of a plurality of tooth parts of the first saw-toothed structure. When the poking part is moved to allow the contacting part to be accommodated within the indentation, the wheel is non-rotatable.

In an embodiment, the first inner surface of the recess further includes a third saw-toothed structure. The first saw-toothed structure and the third saw-toothed structure are arranged on the first inner surface side by side. In addition, the first saw-toothed structure and the third saw-toothed structure have different altitudes. When the poking part is moved to allow the contacting part to be contacted with the third saw-toothed structure, the wheel is operated in a third click-feeling mode.

In an embodiment, the second inner surface of the recess further includes a fourth saw-toothed structure. The second saw-toothed structure and the fourth saw-toothed structure are arranged on the second inner surface side by side. In addition, the second saw-toothed structure and the fourth saw-toothed structure have different altitudes. When the poking part is moved to allow the contacting part to be contacted with the fourth saw-toothed structure, the wheel is operated in a fourth click-feeling mode.

In an embodiment, the second inner surface of the recess further includes a stopping structure with a plurality of indentations. The second stopping structure and the fourth saw-toothed structure are arranged on the second inner surface side by side. In addition, the second stopping structure and the fourth saw-toothed structure have different altitudes. When the poking part is moved to allow the contacting part to be accommodated within one of the indentations, the wheel is non-rotatable.

In an embodiment, the input device has a casing. Moreover, a plurality of position-limiting holes are located at a bottom surface of the casing. An end of the poking part is inserted into one of the position-limiting holes, so that the end of the poking part is exposed outside the casing.

In an embodiment, an opening is formed in a top surface of the casing, wherein the wheel is partially exposed outside the casing through the opening.

In an embodiment, the swinging arm further includes a linking part, which is arranged between the contacting part and the poking part. As the poking part is moved, the contacting part is synchronously moved with the poking part through the linking part.

In an embodiment, the plurality of position-limiting holes include a first position-limiting hole, a second position-limiting hole and a third position-limiting hole. When the poking part is moved to the first position-limiting hole, the contacting part is contacted with the first saw-toothed structure. When the poking part is moved to the second position-limiting hole, the contacting part is contacted with the second saw-toothed structure. When the poking part is moved to the third position-limiting hole, the contacting part is separated from the first saw-toothed structure and the second saw-toothed structure.

In an embodiment, the input device is a mouse device, a keyboard device or a mobile communication device.

In accordance with another aspect of the present invention, there is provided a wheel module for an input device. The wheel module includes a fixing shaft, a wheel and a swinging arm. The wheel is rotatable relative to a central axial line of the fixing shaft. The wheel has a hollow groove. A groove inner surface of the hollow groove has a first saw-toothed structure and a second saw-toothed structure. The first saw-toothed structure and the second saw-toothed structure are arranged on the groove inner surface side by side. In addition, the first saw-toothed structure and the second saw-toothed structure have different altitudes. The swinging arm includes a contacting part and a poking part. As the poking part is moved, the contacting part is selectively contacted with the first saw-toothed structure or the second saw-toothed structure. When the contacting part is contacted with the first saw-toothed structure, the wheel is operated in a first click-feeling mode. When the contacting part is contacted with the second saw-toothed structure, the wheel is operated in a second click-feeling mode.

In an embodiment, the wheel module further provides an elastic force to the swinging arm. In response to the elastic force, the contacting part is contacted with the first saw-toothed structure or the second saw-toothed structure.

In an embodiment, the swinging arm is made of an elastic material for generating the elastic force.

In an embodiment, the wheel module further includes a spring, which is connected with the swinging arm for providing the elastic force.

In an embodiment, the groove inner surface of the hollow groove further includes a smooth surface. The smooth surface, the first saw-toothed structure and the second saw-toothed structure are arranged on the groove inner surface side by side. In addition, the smooth surface, the first saw-toothed structure and the second saw-toothed structure have different altitudes. When the poking part is moved to allow the contacting part to be contacted with the smooth surface, the wheel is operated in a smooth-feeling mode.

In an embodiment, the input device has a casing. Moreover, a first position-limiting hole and a second position-limiting hole are located at a bottom surface of the casing. An end of the poking part is inserted into the first position-limiting hole or the second position-limiting hole, so that the end of the poking part is exposed outside the casing.

In an embodiment, an opening is formed in a top surface of the casing, wherein the wheel is partially exposed outside the casing through the opening.

In an embodiment, the swinging arm further includes a linking part, which is arranged between the contacting part and the poking part. As the poking part is moved, the contacting part is synchronously moved with the poking part through the linking part.

In an embodiment, when the poking part is moved to the first position-limiting hole, the contacting part is contacted with the first saw-toothed structure. When the poking part is moved to the second position-limiting hole, the contacting part is contacted with the second saw-toothed structure.

In an embodiment, the input device is a mouse device, a keyboard device or a mobile communication device.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional mouse device;

FIG. 2 is a schematic perspective view illustrating a wheel module for the mouse device as shown in FIG. 1;

FIG. 3 is a schematic perspective view illustrating a wheel module for an input device according to a first embodiment of the present invention;

FIG. 4 is a schematic side view illustrating the wheel module of FIG. 3;

FIG. 5A schematically illustrates the wheel module of FIG. 3, in which the wheel is operated in a first click-feeling mode;

FIG. 5B schematically illustrates the wheel module of FIG. 3, in which the wheel is operated in a second click-feeling mode;

FIG. 5C schematically illustrates the wheel module of FIG. 3, in which the wheel is operated in a first smooth-feeling mode;

FIG. 6 is a schematic perspective view illustrating a wheel module for an input device according to a second embodiment of the present invention;

FIG. 7 is a schematic side view illustrating the wheel module of FIG. 6;

FIG. 8 schematically illustrates the wheel module of FIG. 6, in which the wheel is operated in a locking mode;

FIG. 9 is a schematic perspective view illustrating a wheel module for an input device according to a third embodiment of the present invention;

FIG. 10 schematically illustrates the wheel module of FIG. 9, in which the wheel is operated in different modes;

FIG. 11 is a schematic perspective view illustrating a wheel module for an input device according to a fourth embodiment of the present invention;

FIG. 12A schematically illustrates the wheel module of FIG. 11, in which the wheel is operated in a first click-feeling mode;

FIG. 12B schematically illustrates the wheel module of FIG. 11, in which the wheel is operated in a second click-feeling mode;

FIG. 12C schematically illustrates the wheel module of FIG. 11, in which the wheel is operated in a third click-feeling mode;

FIG. 12D schematically illustrates the wheel module of FIG. 11, in which the wheel is operated in a second smooth-feeling mode;

FIG. 12E schematically illustrates the wheel module of FIG. 11, in which the wheel is operated in a locking mode;

FIG. 13 is a schematic perspective view illustrating a mouse device having the wheel module according to the fourth embodiment of the present invention;

FIG. 14 is a schematic perspective view illustrating the mouse device of FIG. 13 and taken along another viewpoint; and

FIG. 15 is a schematic perspective view illustrating the internal portion of the mouse device as shown in FIG. 13.

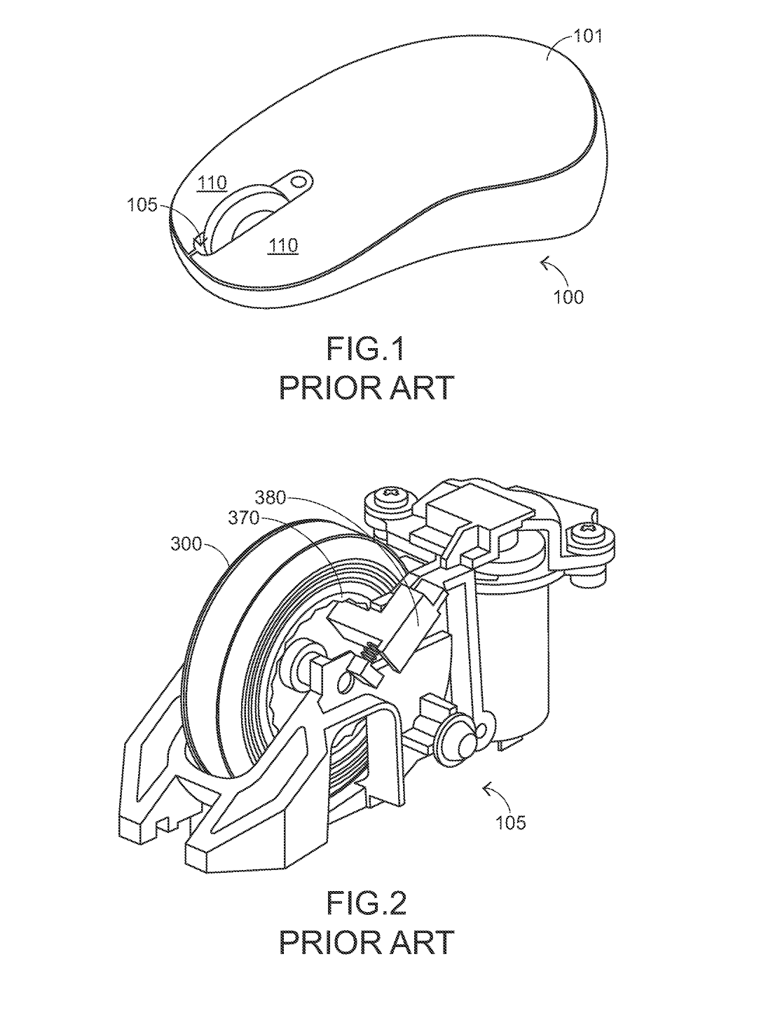

### DETAILED DESCRIPTION OF THE PREFERRED EMBODIMENT

The present invention provides a wheel module. By operating the wheel module, a corresponding electronic device can be controlled. The wheel module may be installed in various input devices such as mouse devices, keyboard devices, mobile phones or personal digital assistants (PDA). The applications of the wheel module are not restricted to these input devices.

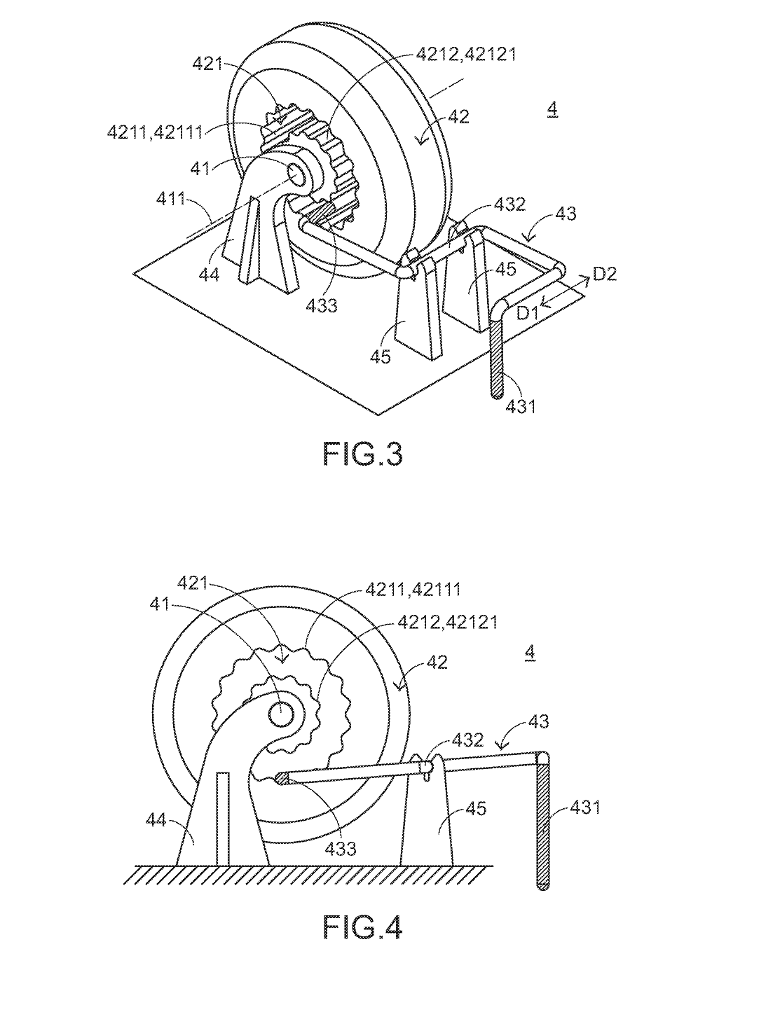

Please refer to FIGS. 3 and 4. FIG. 3 is a schematic perspective view illustrating a wheel module for an input device according to a first embodiment of the present invention. FIG. 4 is a schematic side view illustrating the wheel module of FIG. 3. As shown in FIGS. 3 and 4, the wheel module 4 comprises a fixing shaft 41, a wheel 42 and a swinging arm 43. The wheel 42 is rotatable relative to a central axial line 411 of the fixing shaft 41. Moreover, according to the rotating distance of the wheel 43, a corresponding control signal is outputted from the input device (not shown) to an electronic device (not shown), which is in communication with the input device. The electronic device is for example a computer. In this embodiment, the wheel module 4 further comprises two supporting posts 44. The supporting posts 44 are located at bilateral sides of the wheel 43 for supporting the fixing shaft 41. The way of fixing the fixing shaft 41 is by the supporting posts 44 is presented herein for purpose of illustration and description only.

Moreover, the wheel 42 of the wheel module 4 has a recess 421, which is disposed around the fixing shaft 41. The recess 421 further comprises a first inner surface 4211 and a second inner surface 4212. The second inner surface 4212 is opposed to the first inner surface 4211. The first inner surface 4211 has a first saw-toothed structure 42111. In addition, the second inner surface 4212 has a second saw-toothed structure 42121.

Moreover, the swinging arm 43 of the wheel module 4 comprises a poking part 431, a linking part 432 and a contacting part 433. The linking part 432 is arranged between the contacting part 433 and the poking part 431. As the poking part 431 is moved, the contacting part 433 is synchronously moved with the poking part 431 through the linking part 432. The poking part 431 may be manually moved. Alternatively, the movement of the poking part 431 may be driven by a driving mechanism that is coupled with the poking part 431. Such a driving mechanism is for example a motor, an electromagnet or a voice coil.

In this embodiment, the wheel module 4 further comprises a supporting part 45 for supporting the linking part 432. By using the connecting region between the linking part 432 and the supporting part 45 as a fulcrum, a lever motion of the swinging arm 43 is permitted. For example, the swinging arm 43 may be tilted in a direction D1 or a direction D2. The way of allowing the contacting part 433 to be synchronously moved with the poking part 431 is presented herein for purpose of illustration and description only. According to the position of the contacting part 433 of the swinging arm 43, the wheel 42 of the wheel module 4 can be operated in a first click-feeling mode, a second click-feeling mode or a smooth-feeling mode.

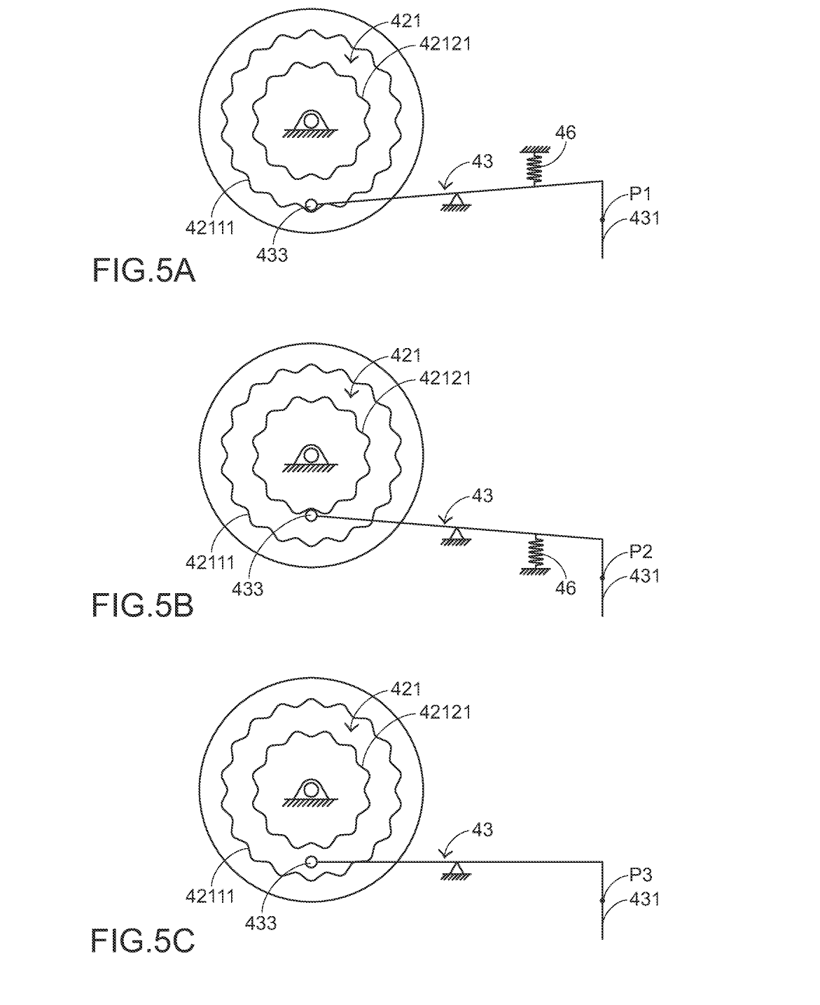

FIG. 5A schematically illustrates the wheel module of FIG. 3, in which the wheel is operated in a first click-feeling mode. In a case that the poking part 431 of the swinging arm 43 is moved upwardly and fixed at a position P1, the contacting part 433 is sustained against the first saw-toothed structure 42111, and thus the wheel 42 is operated in the first click-feeling mode. Meanwhile, the first saw-toothed structure 42111 is impeded by the contacting part 433. For allowing rotation of the wheel 42, it is necessary to apply a pushing force on the wheel 42 to overcome the impeding action of the contacting part 433 on the saw-toothed structure 42111. When the rotation of the wheel 42 is started, the wheel module 4 will conveniently provide an elastic force to the swinging arm 43. In response to the elastic force, the contacting part 433 is sustained against the first saw-toothed structure 42111 again. Similarly, for allowing rotation of the wheel 42 again, it is necessary to apply an additional pushing force on the wheel 42 to overcome the impeding action of the contacting part 433 on the first saw-toothed structure 42111. In other words, once the wheel 42 is rotated for a revolution, the user may sense a plurality of times of the click feeling. The number of times the user senses the click feeling in response to one revolution of the wheel 42 is dependent on the teeth number of the first saw-toothed structure 42111.

It is noted that the elastic force may be provided by the swinging arm 43 itself. That is, the swinging arm 43 is made of an elastic material. After the impeding action of the contacting part 433 on the first saw-toothed structure 42111 is overcome, the elastic force provided by the swinging arm 43 allows the contacting part 433 to be sustained against the first saw-toothed structure 42111 again. Alternatively, the swinging arm 43 is made of a rigid material or a low elasticity-coefficient material. Under this circumstance, an additional spring 46 is connected with the swinging arm 43. After the impeding action of the contacting part 433 on the first saw-toothed structure 42111 is overcome, the elastic force provided by the spring 46 allows the contacting part 433 to be sustained against the first saw-toothed structure 42111 again.

FIG. 5B schematically illustrates the wheel module of FIG. 3, in which the wheel is operated in a second click-feeling mode. In a case that the poking part 431 of the swinging arm 43 is moved downwardly and fixed at a position P2, the contacting part 433 is sustained against the second saw-toothed structure 42121, and thus the wheel 42 is operated in the second click-feeling mode. Meanwhile, the second saw-toothed structure 42121 is impeded by the contacting part 433. For allowing rotation of the wheel 42, it is necessary to apply a pushing force on the wheel 42 to overcome the impeding action of the contacting part 433 on the second saw-toothed structure 42121. When the rotation of the wheel 42 is started, the wheel module 4 will conveniently provides another elastic force to the swinging arm 43. In response to the elastic force, the contacting part 433 is sustained against the second saw-toothed structure 42121 again. Similarly, for allowing rotation of the wheel 42 again, it is necessary to apply an additional pushing force on the wheel 42 to overcome the impeding action of the contacting part 433 on the second saw-toothed structure 42121. In other words, once the wheel 42 is rotated for a revolution, the user may sense a plurality of times of the click feeling. The number of times the user senses the click feeling in response to one revolution of the wheel 42 is dependent on the teeth number of the second saw-toothed structure 42121.

Similarly, the elastic force may be provided by the swinging arm 43 itself. That is, the swinging arm 43 is made of an elastic material. After the impeding action of the contacting part 433 on the second saw-toothed structure 42121 is overcome, the elastic force provided by the swinging arm 43 allows the contacting part 433 to be sustained against the second saw-toothed structure 42121. Alternatively, the swinging arm 43 is made of a rigid material or a low elasticity-coefficient material. Under this circumstance, an additional spring 46 is connected with the swinging arm 43. After the impeding action of the contacting part 433 on the second saw-toothed structure 42121 is overcome, the elastic force provided by the spring 46 allows the contacting part 433 to be sustained against the second saw-toothed structure 42121 again.

FIG. 5C schematically illustrates the wheel module of FIG. 3, in which the wheel is operated in a first smooth-feeling mode. In a case that the poking part 431 of the swinging arm 43 is moved and fixed at a third position P3, the contacting part 433 is separated from the first saw-toothed structure 42111 and the second saw-toothed structure 42121, and thus the wheel 42 is operated in the smooth-feeling mode. Meanwhile, both of the first saw-toothed structure 42111 and the second saw-toothed structure 42121 are not impeded by the contacting part 433. When a pushing force is exerted on the wheel 42, the momentum is increased. After the pushing force is eliminated, the wheel 42 may be continuously rotated for a certain time period because of the inertia effect. Under this circumstance, the wheel 42 is smoothly rotated without causing the click feeling.

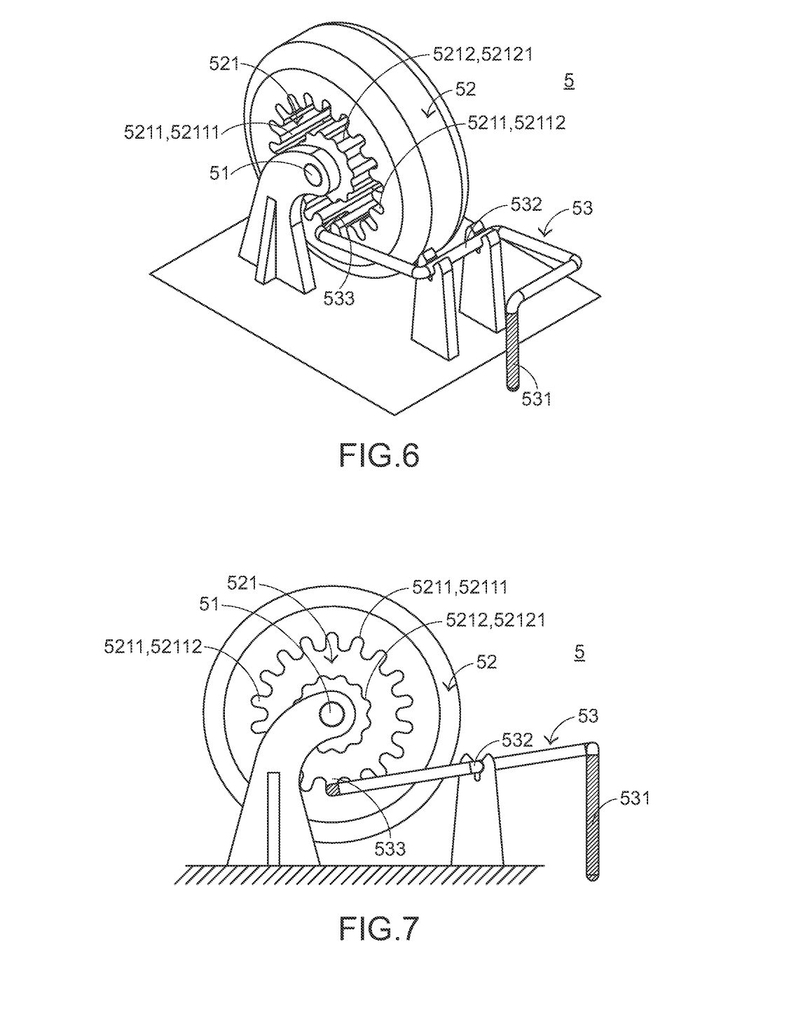

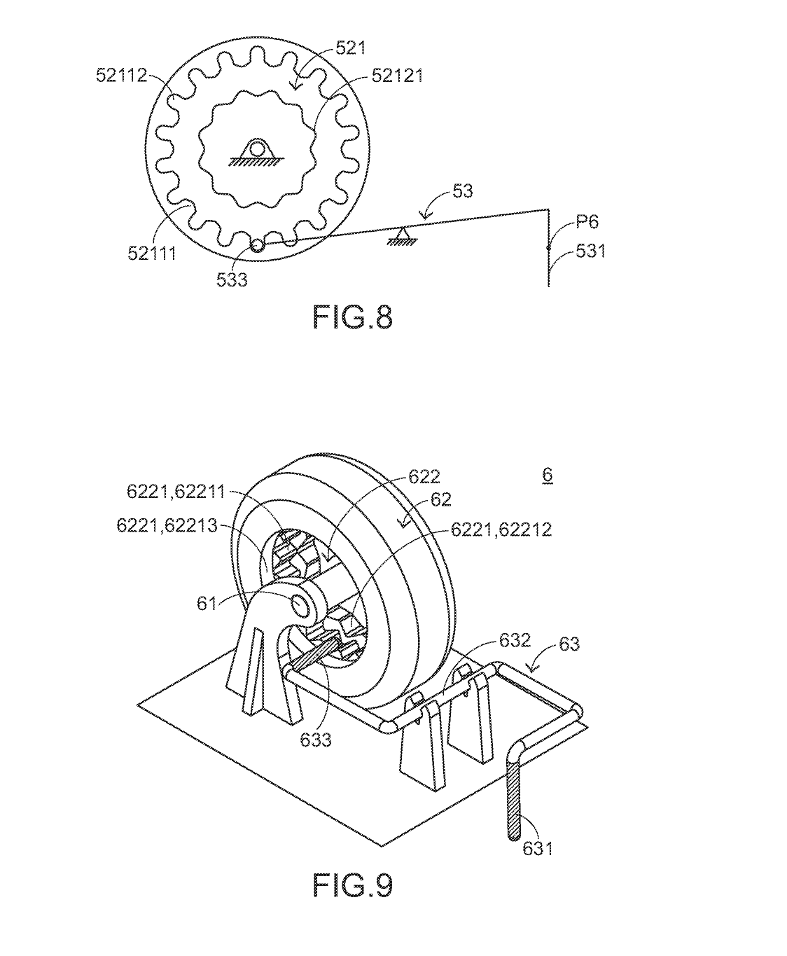

FIG. 6 is a schematic perspective view illustrating a wheel module for an input device according to a second embodiment of the present invention. FIG. 7 is a schematic side view illustrating the wheel module of FIG. 6. FIG. 8 schematically illustrates the wheel module of FIG. 6, in which the wheel is operated in a locking mode. Like the first embodiment, the wheel module 5 comprises a fixing shaft 51, a wheel 52 and a swinging arm 53. Moreover, the wheel 52 has a recess 521. The recess 521 further comprises a first inner surface 5211 and a second inner surface 5212. The first inner surface 5211 has a first saw-toothed structure 52111. In addition, the second inner surface 5212 has a second saw-toothed structure 52121. Moreover, the swinging arm 53 of the wheel module 5 comprises a poking part 531, a linking part 532 and a contacting part 533.

Except for the following two items, the configurations and functions of the wheel module 5 of the second embodiment are similar to those of the first embodiment, and are not redundantly described herein. Firstly, one indentation 52112 is arranged between every two adjacent ones of a plurality of tooth parts of the first saw-toothed structure 52111. In such way, the wheel 52 can be operated in a first click-feeling mode, a second click-feeling mode, a smooth-feeling mode or further a locking mode. In a case that the poking part 531 of the swinging arm 53 is moved and fixed at a position P6, the contacting part 533 is accommodated within any indentation 52112, and thus the wheel 52 is operated in the locking mode. Under this circumstance, the wheel 52 is non-rotatable.

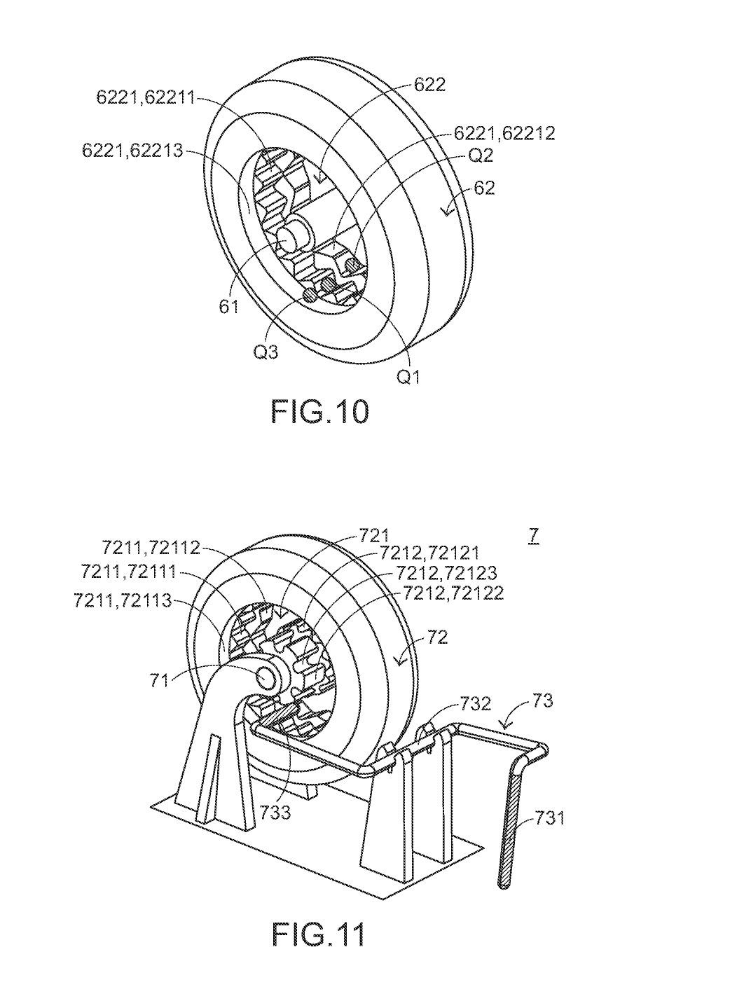

FIG. 9 is a schematic perspective view illustrating a wheel module for an input device according to a third embodiment of the present invention. FIG. 10 schematically illustrates the wheel module of FIG. 9, in which the wheel is operated in different modes. Like the first embodiment, the wheel module 6 comprises a fixing shaft 61, a wheel 62 and a swinging arm 63. Moreover, the swinging arm 63 of the wheel module 6 comprises a poking part 631, a linking part 632 and a contacting part 633.

Except for the following items, the configurations and functions of the wheel module 6 of the third embodiment are similar to those of the first embodiment, and are not redundantly described herein. For example, the wheel 62 of the wheel module 6 has a hollow grove 622. The hollow grove 622 has a groove inner surface 6221. The groove inner surface 6221 comprises a saw-toothed structure 62211, another saw-toothed structure 62212 and a smooth structure 62213. The saw-toothed structure 62211, the saw-toothed structure 62212 and the smooth structure 62213 are arranged on the groove inner surface 6221 in a side-by-side manner. Moreover, the saw-toothed structure 62211, the saw-toothed structure 62212 and the smooth structure 62213 have different altitudes.

Moreover, as the poking part 631 of the swinging arm 63 is moved to allow the contacting part 633 to be fixed at a position Q1, the contacting part 633 is sustained against the saw-toothed structure 62211, and thus the wheel 62 is operated in a click-feeling mode. As the poking part 631 of the swinging arm 63 is moved to allow the contacting part 633 to be fixed at a position Q2, the contacting part 633 is sustained against the saw-toothed structure 62212, and thus the wheel 62 is operated in another click-feeling mode. As the poking part 631 of the swinging arm 63 is moved to allow the contacting part 633 to be fixed at a position Q3, the contacting part 633 is sustained against the smooth structure 62213, and thus the wheel 62 is operated in a smooth-feeling mode. The principles of providing the click feeling and the smooth feeling when the wheel 62 is rotated in different modes are similar to those of the first embodiment, and are not redundantly described herein.

FIG. 11 is a schematic perspective view illustrating a wheel module for an input device according to a fourth embodiment of the present invention. Like the first embodiment, the wheel module 7 comprises a fixing shaft 71, a wheel 72 and a swinging arm 73. Moreover, the wheel 72 has a recess 721 with a first inner surface 7211 and a second inner surface 7212. The first inner surface 7211 has a first saw-toothed structure 72111. The second inner surface 7212 has a second saw-toothed structure 72121. Similarly, the swinging arm 73 comprises a poking part 731, a linking part 732 and a contacting part 733.

Except for the following items, the configurations and functions of the wheel module 7 of the fourth embodiment are similar to those of the first embodiment, and are not redundantly described herein. For example, the first inner surface 7211 further comprises a third saw-toothed structure 72112 and a smooth structure 72113, and the second inner surface 7212 further comprises a stopping structure 72122 with a plurality of indentations 72123. The first saw-toothed structure 72111, the third saw-toothed structure 72112 and the smooth structure 72113 are arranged on the first inner surface 7211 in a side-by-side manner. Moreover, the first saw-toothed structure 72111, the third saw-toothed structure 72112 and the smooth structure 72113 have different altitudes. The stopping structure 72122 and the second saw-toothed structure 72121 are arranged on the second inner surface 7212 in a side-by-side manner. Moreover, stopping structure 72122 and the second saw-toothed structure 72121 have different altitudes.

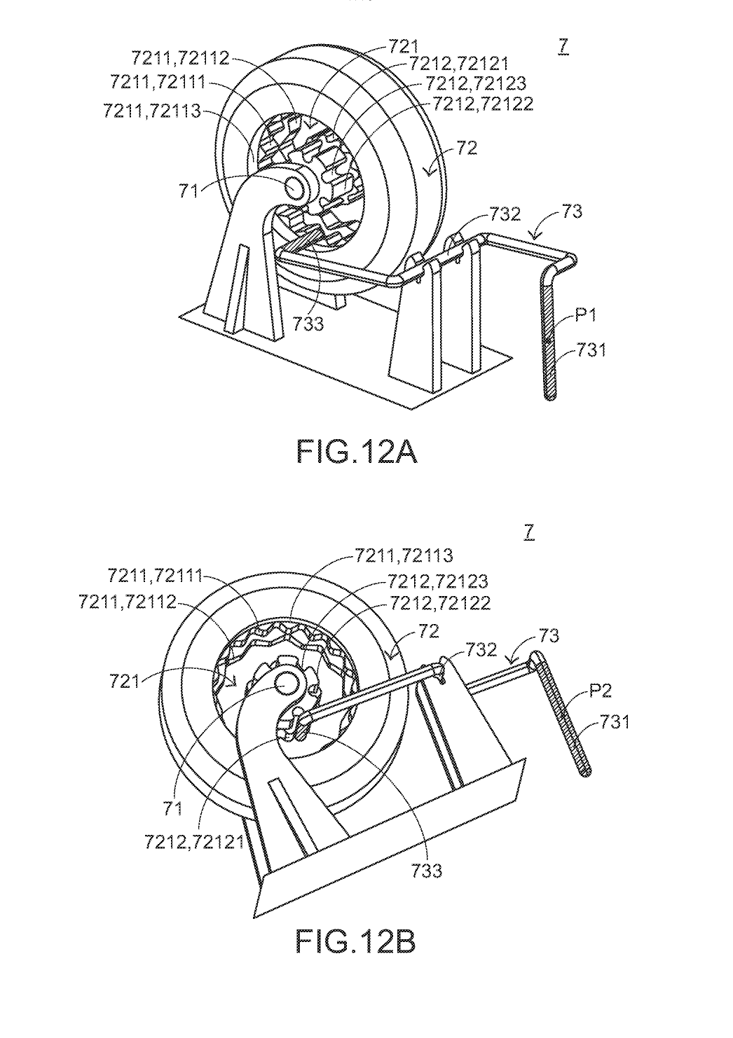

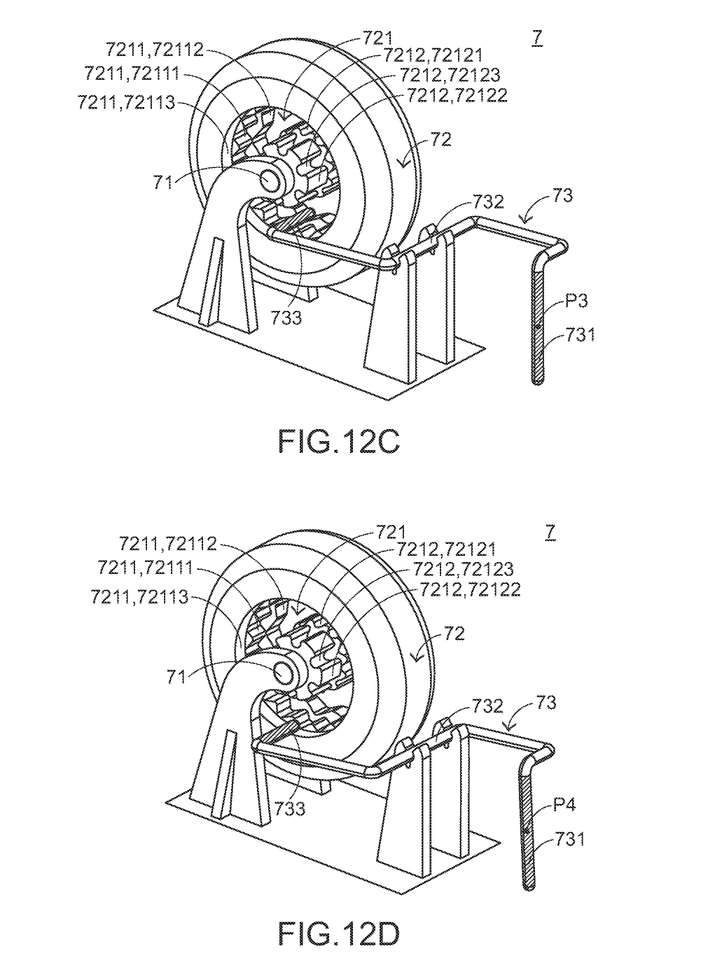

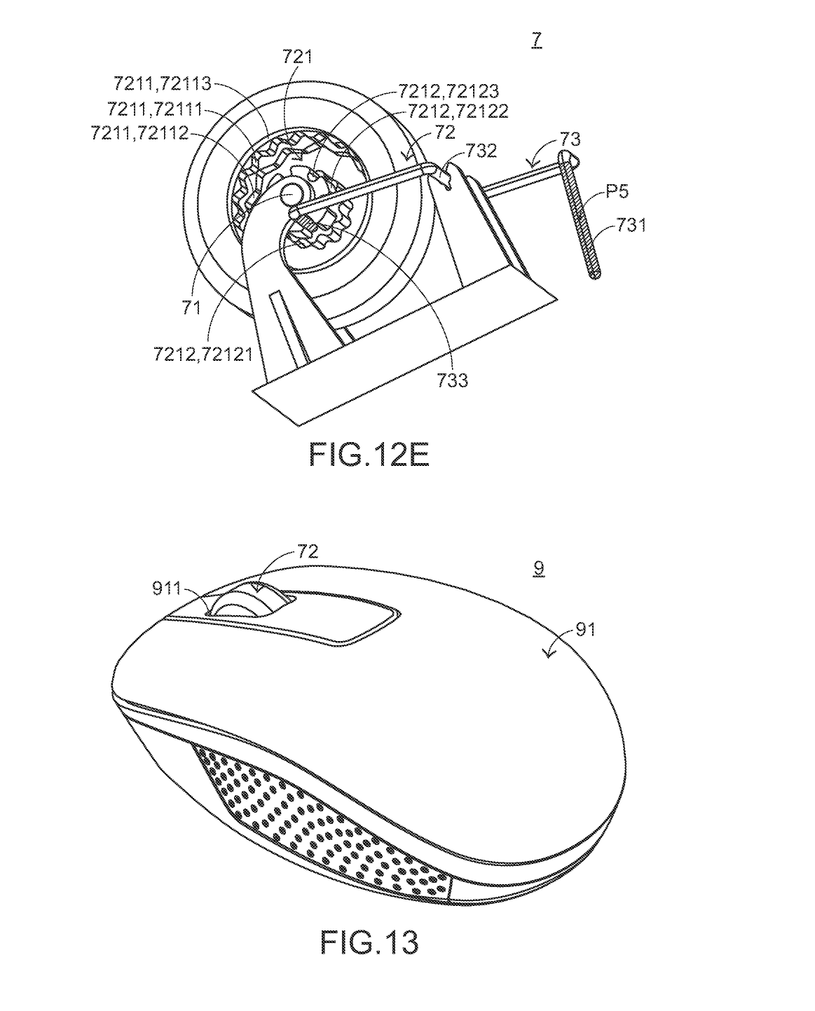

FIG. 12A schematically illustrates the wheel module of FIG. 11, in which the wheel is operated in a first click-feeling mode. In a case that the poking part 731 of the swinging arm 73 is moved and fixed at a position P1, the contacting part 733 is sustained against the first saw-toothed structure 72111, and thus the wheel 72 is operated in the first click-feeling mode.

FIG. 12B schematically illustrates the wheel module of FIG. 11, in which the wheel is operated in a second click-feeling mode. In a case that the poking part 731 of the swinging arm 73 is moved and fixed at a position P2, the contacting part 733 is sustained against the second saw-toothed structure 72121, and thus the wheel 72 is operated in the second click-feeling mode.

FIG. 12C schematically illustrates the wheel module of FIG. 11, in which the wheel is operated in a third click-feeling mode. In a case that the poking part 731 of the swinging arm 73 is moved and fixed at a position P3, the contacting part 733 is sustained against the third saw-toothed structure 72112, and thus the wheel 72 is operated in the third click-feeling mode.

FIG. 12D schematically illustrates the wheel module of FIG. 11, in which the wheel is operated in a second smooth-feeling mode. In a case that the poking part 731 of the swinging arm 73 is moved and fixed at a position P4, the contacting part 733 is sustained against the smooth structure 72113, and thus the wheel 72 is operated in the second smooth-feeling mode.

FIG. 12E schematically illustrates the wheel module of FIG. 11, in which the wheel is operated in a locking mode. In a case that the poking part 731 of the swinging arm 73 is moved and fixed at a position P5, the contacting part 733 is accommodated within one of the indentations 72123, and thus the wheel 72 is operated in the locking mode. Under this circumstance, the wheel 72 is non-rotatable.

The principles of providing the click feeling and the smooth feeling when the wheel 72 is rotated in different modes are similar to those of the first embodiment, and are not redundantly described herein.

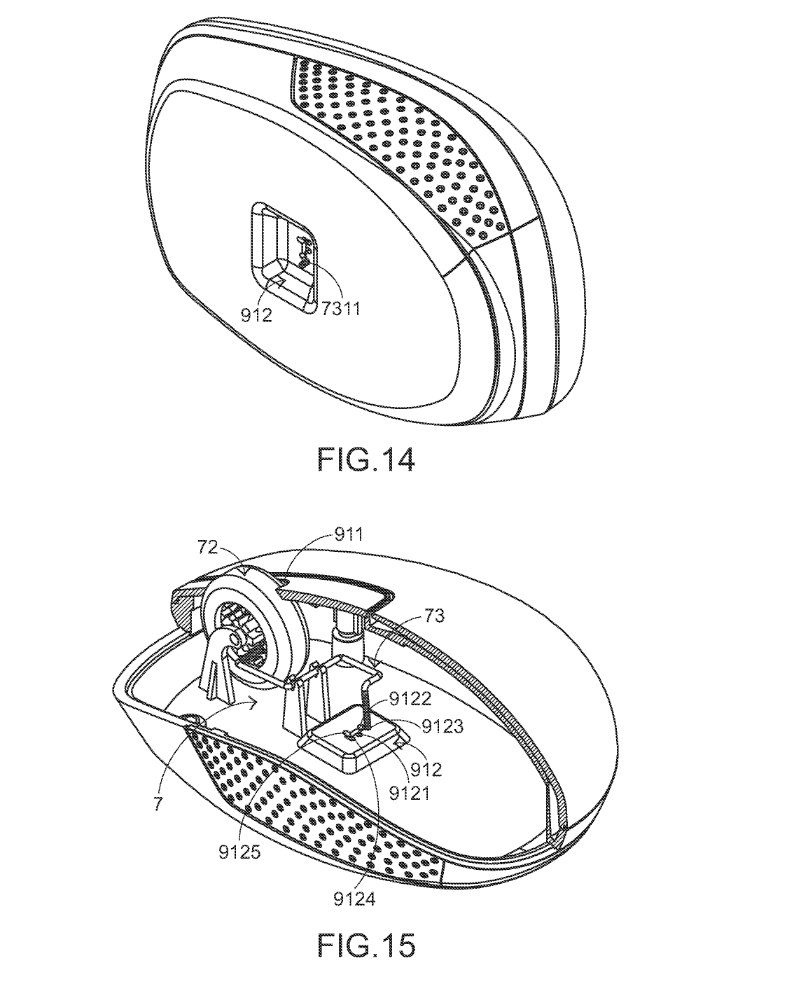

FIG. 13 is a schematic perspective view illustrating a mouse device having the wheel module according to the fourth embodiment of the present invention. FIG. 14 is a schematic perspective view illustrating the mouse device of FIG. 13 and taken along another viewpoint. FIG. 15 is a schematic perspective view illustrating the internal portion of the mouse device as shown in FIG. 13. Please refer to FIGS. 13, 14 and 15. The mouse device 9 has a casing 91. When the casing 91 is held on the palm of a user's hand, the user may move the mouse device. In addition, an opening 911 is formed in a top surface of the casing 91. Through the opening 911, the wheel 72 of the wheel module 7 is partially exposed outside the casing 91. Consequently, the wheel 72 exposed outside the casing 91 can be manipulated by the user's finger.

Moreover, a position-limiting structure 912 is located at the bottom surface of the casing 91. The position-limiting structure 912 comprises a plurality of position-limiting holes 9121˜9125. An end 7311 of the poking part 731 is penetrated through the position-limiting structure 912, so that the end 7311 of the poking part 731 is exposed outside the casing 91. In such way, since the end 7311 of the poking part 731 may be moved to a specified one of the position-limiting holes 9121˜9125 by the user, the operating mode of the wheel 72 can be adjusted according to the practical requirements.

For example, in a case that the end 7311 of the poking part 731 is moved to the first position-limiting hole 9121, the poking part 731 is fixed at the position P1, so that the contacting part 733 is sustained against the first saw-toothed structure 72111. Under this circumstance, the wheel 72 is operated in the first click-feeling mode. In a case that the end 7311 of the poking part 731 is moved to the second position-limiting hole 9122, the poking part 731 is fixed at the position P2, so that the contacting part 733 is sustained against the second saw-toothed structure 72121. Under this circumstance, the wheel 72 is operated in the second click-feeling mode. In a case that the end 7311 of the poking part 731 is moved to the third position-limiting hole 9123, the poking part 731 is fixed at the position P3, so that the contacting part 733 is sustained against the third saw-toothed structure 72112. Under this circumstance, the wheel 72 is operated in the third click-feeling mode. In a case that the end 7311 of the poking part 731 is moved to the fourth position-limiting hole 9124, the poking part 731 is fixed at the position P4, so that the contacting part 733 is sustained against the smooth structure 72113. Under this circumstance, the wheel 72 is operated in the second smooth-feeling mode. In a case that the end 7311 of the poking part 731 is moved to the fifth position-limiting hole 9125, the poking part 731 is fixed at the position P5, so that the contacting part 733 is accommodated within one of the indentations 72123. Under this circumstance, the wheel 72 is operated in the locking mode.

It is noted that the applications of the wheel module in the above embodiments of this invention are presented herein for purpose of illustration and description only. Those skilled in the art will readily observe that numerous modifications and alterations may be made while retaining the teachings of the invention. For example, the position-limiting structure 912 may be located at a sidewall of the casing 91 of the mouse device 9. By retaining the teachings of the above embodiments, the wheel module of the present invention may be applied in other input devices such as keyboard devices or personal digital assistants (PDA).

From the above description, the wheel module for an input device of the present invention may be selectively operated in one of several operating modes according to the user's requirements. Consequently, the application of the professional computer software will be expanded. Take the image processing software for example. In a case that the wheel is operated in the first click-feeling mode, each time of sensing the click feeling of the wheel denotes that the image frame to be processed is enlarged or shrunken by 10%. In a case that the wheel is operated in the second click-feeling mode, each time of sensing the click feeling of the wheel denotes that the image frame to be processed is enlarged or shrunken by 25%. In a case that the wheel is operated in the third click-feeling mode, each time of sensing the click feeling of the wheel denotes that the image frame to be processed is enlarged or shrunken by 40%. It is noted that the applications of the wheel module to the image processing software are presented herein for purpose of illustration and description only. That is, the wheel module may be applied to diverse professional computer software to bring about more benefits.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A wheel module for an input device, said wheel module comprising:
a fixing shaft;
a wheel rotatable relative to a central axial line of said fixing shaft, wherein said wheel has a recess, which is disposed around said fixing shaft, wherein a first inner surface of said recess has a first saw-toothed structure, and a second inner surface of said recess opposite to said first inner surface has a second saw-toothed structure; and
a swinging arm comprising a contacting part and a poking part, wherein as said poking part is moved, said contacting part is selectively contacted with said first saw-toothed structure or said second saw-toothed structure, or separated from said first saw-toothed structure and said second saw-toothed structure,
wherein when said contacting part is contacted with said first saw-toothed structure, said wheel is operated in a first click-feeling mode, wherein when said contacting part is contacted with said second saw-toothed structure, said wheel is operated in a second click-feeling mode, wherein when said contacting part is separated from said first saw-toothed structure and said second saw-toothed structure, said wheel is operated in a smooth-feeling mode.

2. The wheel module according to claim 1 wherein said wheel module further provides an elastic force to said swinging arm, wherein in response to said elastic force, said contacting part is contacted with said first saw-toothed structure or said second saw-toothed structure.

3. The wheel module according to claim 2 wherein said swinging arm is made of an elastic material for generating said elastic force.

4. The wheel module according to claim 2 further comprising a spring, which is connected with said swinging arm for providing said elastic force.

5. The wheel module according to claim 1 wherein one indentation is arranged between every two adjacent ones of a plurality of tooth parts of said first saw-toothed structure, wherein when said poking part is moved to allow said contacting part to be accommodated within said indentation, said wheel is non-rotatable.

6. The wheel module according to claim 1 wherein said first inner surface of said recess further comprises a third saw-toothed structure, wherein said first saw-toothed structure and said third saw-toothed structure are arranged on said first inner surface side by side, and said first saw-toothed structure and said third saw-toothed structure have different altitudes, wherein when said poking part is moved to allow said contacting part to be contacted with said third saw-toothed structure, said wheel is operated in a third click-feeling mode.

7. The wheel module according to claim 6 wherein said second inner surface of said recess further comprises a fourth saw-toothed structure, wherein said second saw-toothed structure and said fourth saw-toothed structure are arranged on said second inner surface side by side, and said second saw-toothed structure and said fourth saw-toothed structure have different altitudes, wherein when said poking part is moved to allow said contacting part to be contacted with said fourth saw-toothed structure, said wheel is operated in a fourth click-feeling mode.

8. The wheel module according to claim 1 wherein said second inner surface of said recess further comprises a stopping structure with a plurality of indentations, wherein said second stopping structure and said fourth saw-toothed structure are arranged on said second inner surface side by side, and said second stopping structure and said fourth saw-toothed structure have different altitudes, wherein when said poking part is moved to allow said contacting part to be accommodated within one of said indentations, said wheel is non-rotatable.

9. The wheel module according to claim 1 wherein said input device has a casing, and a plurality of position-limiting holes are located at a bottom surface of said casing, wherein an end of said poking part is inserted into one of said position-limiting holes, so that said end of said poking part is exposed outside said casing.

10. The wheel module according to claim 9 wherein an opening is formed in a top surface of said casing, wherein said wheel is partially exposed outside said casing through said opening.

11. The wheel module according to claim 9 wherein said swinging arm further comprises a linking part, which is arranged between said contacting part and said poking part, wherein as said poking part is moved, said contacting part is synchronously moved with said poking part through said linking part.

12. The wheel module according to claim 11 wherein said plurality of position-limiting holes comprise a first position-limiting hole, a second position-limiting hole and a third position-limiting hole, wherein when said poking part is moved to said first position-limiting hole, said contacting part is contacted with said first saw-toothed structure, wherein when said poking part is moved to said second position-limiting hole, said contacting part is contacted with said second saw-toothed structure, wherein when said poking part is moved to said third position-limiting hole, said contacting part is separated from said first saw-toothed structure and said second saw-toothed structure.

13. The wheel module according to claim 1 wherein said input device is a mouse device, a keyboard device or a mobile communication device.

14. A wheel module for an input device, said wheel module comprising:
a fixing shaft;
a wheel rotatable relative to a central axial line of said fixing shaft, wherein said wheel has a hollow groove, wherein a groove inner surface of said hollow groove has a first saw-toothed structure and a second saw-toothed structure, wherein said first saw-toothed structure and said second saw-toothed structure are arranged on said groove inner surface side by side, and said first saw-toothed structure and said second saw-toothed structure have different altitudes; and
a swinging arm comprising a contacting part and a poking part, wherein as said poking part is moved, said contacting part is selectively contacted with said first saw-toothed structure or said second saw-toothed structure,
wherein when said contacting part is contacted with said first saw-toothed structure, said wheel is operated in a first click-feeling mode, wherein when said contacting part is contacted with said second saw-toothed structure, said wheel is operated in a second click-feeling mode.

15. The wheel module according to claim 14 wherein said wheel module further provides an elastic force to said swinging arm, wherein in response to said elastic force, said contacting part is contacted with said first saw-toothed structure or said second saw-toothed structure.

16. The wheel module according to claim 15 wherein said swinging arm is made of an elastic material for generating said elastic force.

17. The wheel module according to claim 15 further comprising a spring, which is connected with said swinging arm for providing said elastic force.

18. The wheel module according to claim 14 wherein said groove inner surface of said hollow groove further comprises a smooth surface, wherein said smooth surface, said first saw-toothed structure and said second saw-toothed structure are arranged on said groove inner surface side by side, and said smooth surface, said first saw-toothed structure and said second saw-toothed structure have different altitudes, wherein when said poking part is moved to allow said contacting part to be contacted with said smooth surface, said wheel is operated in a smooth-feeling mode.

19. The wheel module according to claim 14 wherein said input device has a casing, wherein a first position-limiting hole and a second position-limiting hole are located at a bottom surface of said casing, wherein an end of said poking part is inserted into said first position-limiting hole or said second position-limiting hole, so that said end of said poking part is exposed outside said casing.

20. The wheel module according to claim 19 wherein an opening is formed in a top surface of said casing, wherein said wheel is partially exposed outside said casing through said opening.

21. The wheel module according to claim 19 wherein said swinging arm further comprises a linking part, which is arranged between said contacting part and said poking part, wherein as said poking part is moved, said contacting part is synchronously moved with said poking part through said linking part.

22. The wheel module according to claim 21 wherein when said poking part is moved to said first position-limiting hole, said contacting part is contacted with said first saw-toothed structure, wherein when said poking part is moved to said second position-limiting hole, said contacting part is contacted with said second saw-toothed structure.

23. The wheel module according to claim 14 wherein said input device is a mouse device, a keyboard device or a mobile communication device.
